(19) United States
(12) Patent Application Publication
(10) Pub. No.: US 2026/0120942 A1
(43) Pub. Date: Apr. 30, 2026

(54) COIL ELECTRONIC COMPONENT

(71) Applicant: SAMSUNG ELECTRO-MECHANICS CO., LTD., Suwon-si (KR)

(72) Inventors: Han Lee, Suwon-si (KR); Boumseock Kim, Suwon-si (KR)

(73) Assignee: SAMSUNG ELECTRO-MECHANICS CO., LTD., Suwon-si (KR)

(21) Appl. No.: 19/170,885

(22) Filed: Apr. 4, 2025

(30) Foreign Application Priority Data
Oct. 30, 2024 (KR) 10-2024-0150371

(51) Int. Cl. H01F 27/29; H01F 27/06; H01F 27/32

(52) U.S. Cl. CPC H01F 27/29; H01F 27/06; H01F 27/324

(57) ABSTRACT

A coil electronic component includes a support member, a coil disposed on the support member, and a body that surrounds the support member and the coil and contains a magnetic material. The coil comprises an inner coil and an outer coil sequentially disposed proximate to the support member, wherein the outer coil is electrically connected to the inner coil. A ratio of the cross-sectional area of each turn of the inner coil to the cross-sectional area of each turn of the outer coil is 1100/1150 or more and 1200/1150 or less.

### CROSS-REFERENCE TO RELATED APPLICATION

This application claims priority to and the benefit of Korean Patent Application No. 10-2024-0150371 filed with the Korean Intellectual Property Office on Oct. 30, 2024, the entire contents of which are incorporated herein by reference.

### BACKGROUND

### 1. Field

The present disclosure relates to a coil-type electronic component.

### 2. Description of the Related Art

As the functions of mobile devices have diversified recently, power consumption has increased, and thus coil electronic components with low loss and high efficiency are being adopted around power management integrated circuits (PMICs) to extend battery life in mobile devices.

Among these, a thin film type inductor may be manufactured by forming a coil on a support member by sputtering or plating. A thin film inductor having a multi-layer structure of coils to increase inductance has a plurality of coil layers connected through vias. In this case, the DC resistance increases as the inductor capacity increases, which poses a challenge.

### SUMMARY

One aspect of the embodiment is to provide a coil electronic component that can reduce DC resistance.

However, the problems that the present embodiments seek to solve are not limited to the those described above and can be expanded in various ways within the range of technical ideas included in the present embodiment.

A coil electronic component according to an embodiment includes: a support member; a coil disposed on the support member; and a body that surrounds the support member and the coil, and contains a magnetic material, wherein the coil may include an inner coil and an outer coil disposed in order proximate to the support member, the outer coil may be connected to the inner coil, and a ratio of the cross-sectional area of each turn of the inner coil to the cross-sectional area of each turn of the outer coil may be 1100/1150 or more and 1200/1150 or less.

The coil electronic component may further include an insulation layer disposed between the inner coil and the outer coil, and a first via that penetrates the insulation layer to electrically connect the inner coil and the outer coil. The support member may include a first support surface, a second support surface facing the first side, and a second via connecting the first support surface and the second support surface, and the inner coil may include a first inner coil pattern disposed on the first support surface and a second inner coil pattern disposed on the second support surface and connected to the first inner coil pattern through the second via.

The insulation layer may include a first insulation layer covering the first inner coil pattern and a second insulation layer covering the second inner coil pattern.

The outer coil may include a first outer coil pattern disposed on the first insulation layer and a second outer coil pattern disposed on the second insulation layer.

The coil electronic component may further include: a third insulation layer disposed between the first outer coil pattern and the body; and a fourth insulation layer disposed between the second outer coil pattern and the body.

The first outer coil pattern may include a first lead out portion exposed from one surface of the body, and the second outer coil pattern may include a second lead out portion exposed from the other surface of the body.

The coil electronic component may further include: a first external electrode disposed outside the body and connected to the first lead out portion; and a second external electrode disposed outside the body and connected to the second lead out portion.

The coil electronic component may further include a surface insulation layer disposed on an outer surface of the body.

According to the embodiment, a coil electronic component capable of reducing DC resistance is provided.

### BRIEF DESCRIPTION OF THE DRAWINGS

FIG. 1 is a schematic perspective view of a coil electronic component according to an embodiment.

FIG. 2 is a schematic exploded perspective view of the coil electronic component of FIG. 1.

FIG. 3 is a schematic cross-sectional view of FIG. 1, taken along line I-I′.

FIG. 4 is a schematic cross-sectional view of FIG. 1, taken along line II-II′.

### DETAILED DESCRIPTION

Hereinafter, with reference to the accompanying drawings, an embodiment is described in detail such that a person of ordinary skill in the art to which the present invention belongs can easily carry out the present disclosure. The drawings and description are to be regarded as illustrative in nature and not restrictive. Like reference numerals denote like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited to the accompanying drawings, and it will be appreciated that the present invention encompasses all of the modifications, equivalents, and substitutions within the spirit and technical scope of the present invention.

Terms including an ordinal numbers, such as first and second, are used for describing various constituent elements, but the constituent elements are not limited by the terms. The terms are used only to discriminate one constituent element from another constituent element.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly stated otherwise, the word “comprise”, and variations such as “comprises” or “comprising”, will be understood to imply the inclusion of stated elements but not the exclusion of any other elements.

Furthermore, throughout the specification, when it is referred to as “on a plane”, it means when a target part is viewed from above, and when it is referred to as “on a cross-section”, it means when the cross section obtained by cutting a target part vertically is viewed from the side.

Furthermore, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

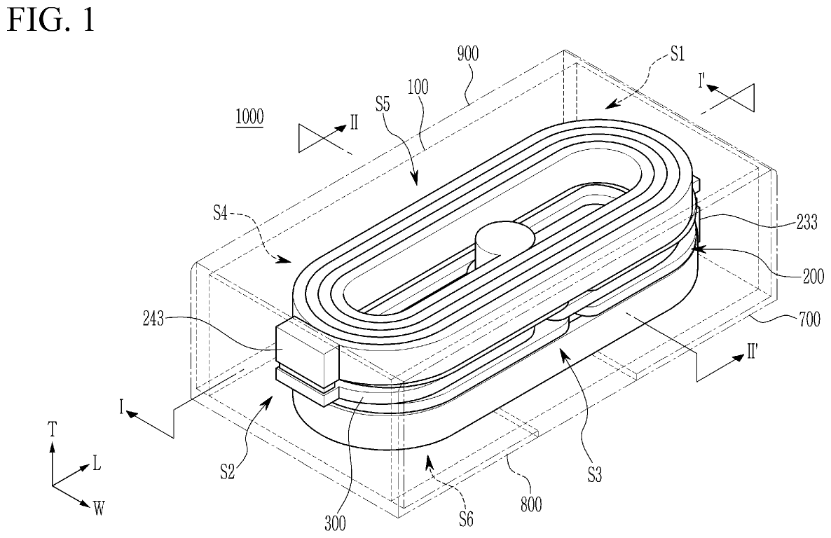

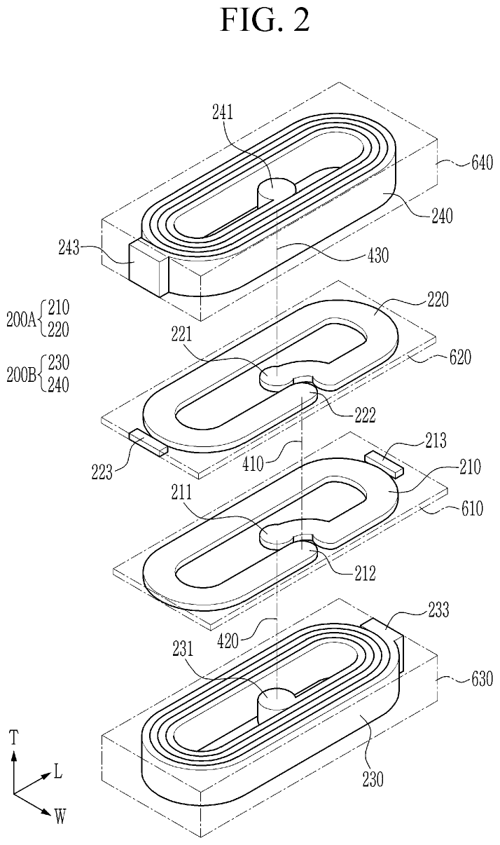

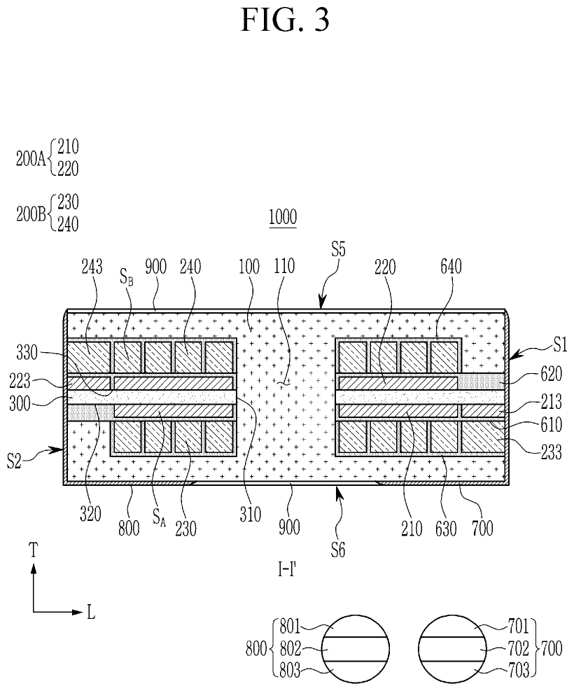

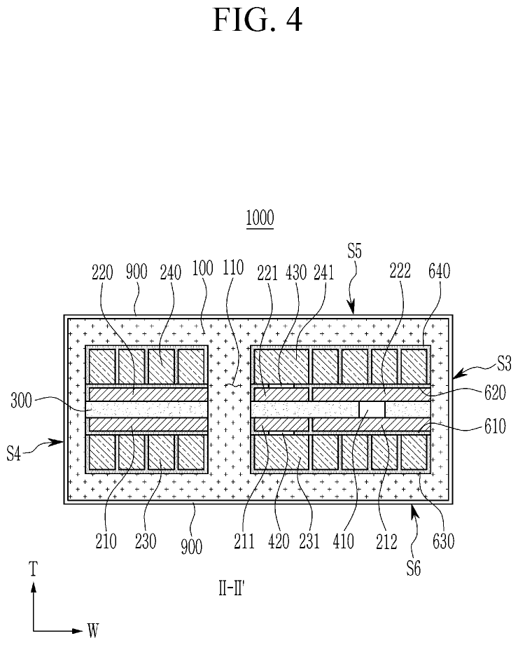

FIG. 1 is a schematic perspective view of a coil electronic component according to an embodiment, FIG. 2 is a schematic exploded perspective view of the coil electronic component of FIG. 1, FIG. 3 is a schematic cross-sectional view of FIG. 1, taken along line I-I′, and FIG. 4 is a schematic cross-sectional view of FIG. 1, taken along line II-II′.

Referring to FIG. 1, FIG. 2, FIG. 3, and FIG. 4, a coil electronic component 1000 according to an embodiment includes a body 100, a coil 200, a support member 300, a first external electrode 700, a second external electrode 800, and a surface insulation layer 900.

The body 100 may have an approximately rectangular hexahedral shape, but the present embodiment is not limited thereto. Due to shrinkage of magnetic powder and the like, during sintering, the body 100 may not have a perfect rectangular hexahedral shape, however may have a substantially rectangular hexahedral shape. For example, the body 100 has an approximately rectangular hexahedral shape, but its corners or vertices may have rounded shapes.

In the present embodiment, for better understanding and ease of description, two surfaces opposing each other in a length direction (L-axis direction) are defined as a first surface S1 and a second surface S2, respectively, two surfaces opposing each other in a width direction (W-axis direction) are defined as a third surface S3 and a fourth surface S4, respectively, and two surfaces opposing each other in a thickness direction (T-axis direction) are defined as a fifth surface S5 and a sixth surface S6, respectively.

With reference to an optical microscope or scanning electron microscope (SEM) photograph of a cross-section taken along the length direction (L-axis direction)-thickness direction (T-axis direction) at a central portion of the coil electronic component 1000 in the width direction (W-axis direction), a length of the coil electronic component 1000 may refer to a maximum value among lengths of a plurality of line segments that connect the two outermost boundary lines opposing each other in the length direction (L-axis direction) and are parallel to the length direction (L-axis direction) of the coil electronic component 1000 shown in the cross-section photograph mentioned above. Alternatively, the length of the coil electronic component 1000 may refer to a minimum value among the lengths of the plurality of line segments that connect the two outermost boundary lines opposing each other in the length direction (L-axis direction) and are parallel to the length direction (L-axis direction) of the coil electronic component 1000 shown in the cross-section photograph described above. Alternatively, the length of the coil electronic component 1000 may refer to the arithmetic average value of lengths of at least two line segments among a plurality of line segments that connect the two outermost boundary lines opposing each other in the length direction (L-axis direction) and are parallel to the length direction (L-axis direction) of the coil electronic component 1000 shown in the cross-section photograph described above.

With reference to the optical microscope or SEM photo of a cross-section taken along the length direction (L-axis direction)-thickness direction (T-axis direction) at a central portion of the coil electronic component 1000 in the width direction (W-axis direction), a thickness of the coil electronic component 1000 may be defined asa maximum value among the lengths of the plurality of line segments that connect the two outermost boundary lines opposing each other in the thickness direction (T-axis direction) and are parallel to the thickness direction (T-axis direction) of the coil electronic component 1000 shown in the cross-section photograph described above. Alternatively, the thickness of the coil electronic component 1000 may refer to a minimum value among the lengths of the plurality of line segments that connect the two outermost boundary lines opposing each other in the thickness direction (T-axis direction) and are parallel to the thickness direction (T-axis direction) of the coil electronic component 1000 shown in the cross-section photograph described above. Alternatively, the thickness of the coil electronic component 1000 may refer to the arithmetic average value of the lengths of at least two line segments among a plurality of line segments that connect the two outermost boundary lines opposing each other in the thickness direction (T-axis direction) and are parallel to the thickness direction (T-axis direction) of the coil electronic component 1000 shown in the cross-section photograph described above.

With reference to the optical microscope or SEM (Scanning Electron Microscope) photo of a cross-section taken along the length direction (L-axis direction)-width direction (W-axis direction) at a central portion of the coil electronic component 1000 in the thickness direction (T-axis direction), a width of the coil electronic component 1000 may refer to a maximum value among the lengths of the plurality of line segments that connect the two outermost boundary lines opposing each other in the width direction (W-axis direction) and are parallel to the width direction (W-axis direction) of the coil electronic component 1000 shown in the cross-section photograph described above. Alternatively, the width of the coil electronic component 1000 may refer to a minimum value among the lengths of the plurality of line segments that connect the two outermost boundary lines opposing each other in the width direction (W-axis direction) and are parallel to the width direction (W-axis direction) of the coil electronic component 1000 shown in the cross-section photograph described above. Alternatively, the width of the coil electronic component 1000 may refer to the arithmetic average value of the lengths of at least two line segments among the plurality of line segments that connect the two outermost boundary lines opposing each other in the width direction (W-axis direction) and are parallel to the width direction (W-axis direction) of the coil electronic component 1000 shown in the cross-section photograph described above.

Each of the length, width, and thickness of the coil electronic component 1000 may be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 using the micrometer measurement method, the length of the coil electronic component 1000 may mean a value measured once or mean an arithmetic average of values measured a plurality of times. This may be equally applied to measuring the width and thickness of the coil electronic component 1000.

The body 100 forms an exterior of the coil electronic component 1000, and is a space where a magnetic path, which is a path through which the magnetic flux generated by the coil 200 passes, is formed, when s current is applied to the coil 200 through the first external electrode 700 and the second external electrode 800.

The body 100 surrounds and encapsulates the coil 200 and the support member 300 and includes a magnetic material. The body 100 includes magnetic particles, and an insulating material may be interposed between the magnetic particles.

The magnetic material may include a first metal magnetic particle, a second metal magnetic particle with a smaller particle size than the first metal magnetic particle, and a third metal magnetic particle having a smaller particle size than the second metal magnetic particle. An average particle diameter D₅₀ of the first metal magnetic particle may be 5 μm or more and 30 μm or less, an average particle diameter D₅₀ of the second metal magnetic particle may be 1 μm or more and 5 μm or less, and an average particle diameter D₅₀ of the third metal magnetic particle may be 0.05 μm or more and 0.5 μm or less.

The magnetic particles may be ferrite particles or metal magnetic particles that exhibit magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrite.

The metal magnetic particles may consist of two or more types of powders with different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be either amorphous or crystalline. For example, the metal magnetic particle may be an Fe—Si—B—Cr based amorphous alloy, but the present embodiment is not limited thereto. The metal magnetic particles may have an average particle diameter ranging from approximately 0.1 μm to 30 μm, but are not limited thereto.

In the specification, the average particle diameter may mean a particle size distribution expressed by D₉₀, D₅₀, or the like. The particle size distribution is well known to those skilled in the art as an index indicating what size (particle diameter) particles are included in what proportion in a particle group to be measured. D₅₀ (a particle diameter corresponding to 50% of a cumulative volume of the particle size distribution) refers to an average particle diameter.

The metal magnetic particles may be two or more types of different metal magnetic particles. Herein, by different types of metal magnetic particles, it is meant that the metal magnetic particles are distinguished from each other in at least one of average particle diameter, composition, component ratio, crystallinity, and shape.

The insulating material may include epoxy, polyimide, liquid crystal crystalline polymer, and the like, alone or in combination, but is not limited thereto.

The method for forming the body 100 is not particularly limited. For example, magnetic sheets may be disposed on the upper and lower parts of the coil 200, and then compressed and cured to form the body 100.

The support member 300 is disposed inside the body 100 and supports the coil 200.

The support member 300 may be made of an insulating material including a thermosetting insulating resin such as an epoxy resin, a thermoplastic insulating resin such as a polyimide, or a photosensitive insulating resin, or may be formed by impregnating a reinforcing material such as glass fiber or inorganic filler in the insulating resin. For example, the support member may be made of an insulating material such as Prepreg, ABF (Ajinomoto Build-up Film), FR-4, BT (Bismaleimide Triazine) film, or PID (Photo Imageable Dielectric) film, but the present embodiment is not limited thereto.

At least one selected from the group consisting of silica (SiO₂), alumina (Al₂O₃), silicon carbide (SiC), barium sulfate (BaSO₄), talc, clay, mica powder, aluminum oxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

The support member 300 may include a first support surface 320 and a second support surface 330 which are opposite to each other in the thickness direction (T-axis direction). A through-hole 310 is at a center of the support member 300. The through-hole 310 may be filled with a magnetic material to form a core 110 of the body 100. The core 110 may further improve the inductance of the coil electronic component 1000.

The coil 200 is embedded within the body 100 to exhibit the characteristics of the coil electronic component 1000. For example, when the coil electronic component 1000 of the present embodiment is used as a power inductor, when current is applied to the coil 200, the coil 200 may serve to stabilize the power of an electronic device by storing an electric field in the form of a magnetic field to maintain an output voltage.

The coil 200 may include an inner coil 200A and an outer coil 200B disposed in order proximate to the support member 300.

The outer coil 200B is connected to the inner coil 200A.

The inner coil 200A includes a first inner coil pattern 210 and a second inner coil pattern 220, and the outer coil 200B includes a first outer coil pattern 230 and a second outer coil pattern 240.

The coil 200 may include a structure in which the first outer coil pattern 230, the first inner coil pattern 210, the second inner coil pattern 220, and the second outer coil pattern 240 are stacked along the thickness direction (T-axis direction).

The first outer coil pattern 230, the first inner coil pattern 210, the second inner coil pattern 220, and the second outer coil pattern 240 may each have a planar spiral shape forming at least one turn about the core 110 of the body 100.

The first inner coil pattern 210 is positioned on the first support surface 320 of the support member 300. A first via pad 211 may be positioned at one end of the first inner coil pattern 210, and a second via pad 212 may be positioned at the other end.

A first insulation layer 610 is positioned to cover a portion of the first support surface 320 of the support member 300 and the first inner coil pattern 210.

The second inner coil pattern 220 is positioned on the second support surface 330 of the support member 300. A third via pad 221 may be positioned at one end of the second inner coil pattern 220, and a fourth via pad 222 may be positioned at the other end.

A second insulation layer 620 is positioned to cover a portion of the second support surface 330 of the support member 300 and the second inner coil pattern 220.

The first insulation layer 610 and the second insulation layer 620 may be positioned along a surface of the support member 300 and surfaces of the first and second inner coil patterns 210 and 220. The first insulation layer 610 and the second insulation layer 620 are for insulating the first and second inner coil patterns 210 and 220 from the body 100, and may include a known insulating material such as parylene. Any insulating material may be used for the first and second insulation layers 610 and 620, and there are no particular limitations. For example, the first insulation layer 610 and the second insulation layer 620 may be composed of a polyurethane resin, a polyester resin, an epoxy resin, or a polyamideimide resin. The first insulation layer 610 and the second insulation layer 620 may be formed using a method such as vapor deposition, but are not limited thereto. For example, the first insulation layer 610 and the second insulation layer 620 may be formed by stacking insulating films on both surfaces of the support member 300.

The first outer coil pattern 230 is disposed on the first insulation layer 610. A fifth via pad 231 is positioned at one end of the first outer coil pattern 230, and a first lead out portion 233 is positioned at the other end. The first lead out portion 233 is exposed from the first surface S1 of the body 100 and may be electrically connected to the first external electrode 700.

The second outer coil pattern 240 is positioned on the second insulation layer 620. A sixth via pad 241 is positioned at one end of the second outer coil pattern 240, and a second lead out portion 243 is positioned at the other end.

The second lead out portion 243 is exposed from the second surface S2 of the body 100 and electrically connected to the second external electrode 800.

A third insulation layer 630 is positioned to cover the first outer coil pattern 230, and a fourth insulation layer 640 is positioned to cover the second outer coil pattern 240. That is, the third insulation layer 630 is positioned between the first outer coil pattern 230 and the body 100, and the fourth insulation layer 640 is positioned between the second outer coil pattern 240 and the body 100. The third insulation layer 630 does not exist in a portion where the first outer coil pattern 230 is connected to the first external electrode 700, and the fourth insulation layer 640 does not exist in a portion where the second outer coil pattern 240 is connected to the second external electrode 800.

The third insulation layer 630 and the fourth insulation layer 640 are for insulating the first outer coil pattern 230 and the second outer coil pattern 240 from the body 100, and may include a known insulating material such as parylene. Any insulating material may be used for the third insulation layer 630 and the fourth insulation layer 640, and there are no particular limitations. For example, third insulation layer 630 and the fourth insulation layer 640 may be a polyurethane resin, a polyester resin, an epoxy resin, or a polyamideimide resin. The third insulation layer 630 and the fourth insulation layer 640 may be formed by a method such as vapor deposition, but are not limited thereto. For example, the third insulation layer 630 and the fourth insulation layer 640 may be formed by stacking insulating films on the outer surfaces of the first outer coil pattern 230 and the second outer coil pattern 240.

The coil electronic component 1000 includes a first via 410, a second via 420, and a third via 430.

The first via 410 penetrates the support member 300 to connect the first inner coil pattern 210 and the second inner coil pattern 220. That is, the first via 410 connects the second via pad 212 of the first inner coil pattern 210 and the fourth via pad 222 of the second inner coil pattern 220.

The second via 420 extends through the first insulation layer 610 to connect the first inner coil pattern 210 and the first outer coil pattern 230. That is, the second via 420 connects the first via pad 211 of the first inner coil pattern 210 and the fifth via pad 231 of the first outer coil pattern 230.

The third via 430 extends through the second insulation layer 620 to connect the second inner coil pattern 220 to the second outer coil pattern 240. That is, the third via 430 connects the third via pad 221 of the second inner coil pattern 210 and the sixth via pad 241 of the second outer coil pattern 240.

A first dummy pad 213 may be disposed on the first support surface 320 of the support member 300 opposing the first lead out portion 233. Since the first dummy pad 213 is for maintaining the balance of the coil electronic component 1000 in the length direction (L-axis direction), the first inner coil pattern 210 is not electrically connected to the first dummy pad 213. For example, the first inner coil pattern 210 and the first dummy pad 213 may be made of the same metal, but may be spaced apart from each other.

A second dummy pad 223 may be positioned on the second support surface 330 of the support member 300 opposing the second lead out portion 243. Since the second dummy pad 223 is for maintaining the balance of the coil electronic component 1000 in the length direction (L-axis direction), the second inner coil pattern 220 is not electrically connected to the second dummy pad 223.

For example, the second inner coil pattern 220 and the second dummy pad 223 may be made of the same metal, but may be spaced apart from each other.

The above-described coil patterns and vias may be formed by, for example, plating, and the coil patterns and vias may respectively include a seed layer formed by vapor deposition such as electroless plating or sputtering, and an electroplating layer.

Here, the electroplating layer may be either a single-layer structure or a multi-layer structure. The electroplating layer of the multi-layer structure may be formed in a conformal film structure in which a first electroplating layer is covered by a second electroplating layer, or in the shape of stack in which a second electroplating layer is stacked on only one surface of first electroplating layer.

Meanwhile, when the coil pattern and the via are connected to each other, the seed layer of the coil pattern and the seed layer of the via may be integrally formed such that no boundary is formed therebetween, but the present embodiment is not limited thereto.

The coil patterns 210, 220, 230, and 240 and the vias 410, 420, and 430 may be formed of a conductive material such as copper (Cu), aluminum (Al), silver (Ag), tin (Sn), gold (Au), nickel (Ni), lead (Pb), titanium (Ti), or an alloy thereof, respectively, but is not limited thereto.

A ratio (S_{A}/S_{B}) (hereinafter referred to as an “area ratio”) of a cross-sectional area (S_{B}) of each turn of the inner coil 200A to a cross-sectional area (S_{A}) of each turn of the outer coil 200B of the coil electronic component 1000 may be 1100/1150 or more and 1200/1150 or less.

if the area ratio is less than 1100/1150 or greater than 1200/1150, there is a problem that the DC resistance (Rdc) exceeds a reference value (e.g., 320 mΩ).

Here, the cross-sectional area (S_{A}) of each turn of the inner coil 200A may refer to a cross-sectional area of any turn among a plurality of turns of the inner coil 200A. In addition, the cross-sectional area (S_{B}) of each turn of the outer coil 200B may refer to a cross-sectional area of any turn among a plurality of turns of the outer coil 200B. That is, in the present embodiment, when any one turn of the inner coil 200A and any one turn of the outer coil 200B are each selected, a ratio of the cross-sectional area of the selected turn of the inner coil to the cross-sectional area of the selected turn of the outer coil 200B may be 1100/1150 or more and 1200/1150 or less.

The cross-sectional area (S_{B}) of each turn of the outer coil 200B and the cross-sectional area (S_{A}) of each turn of the inner coil 200A are calculated based on the thickness and width of the cross-section of each turn of the inner coil 200A and the thickness and width of the cross-section of each turn of the outer coil 200B, which are measured based an optical microscope or SEM photograph of a cross-section (hereinafter, “L-T cross-section”) taken along the length direction (L-axis direction)-thickness direction (T-axis direction) to be perpendicular to the width direction (W-axis direction) at a central portion of the coil electronic component 1000 in the width direction (W-axis direction).

For example, a thickness of the cross-section of each turn of the inner coil 200A (or the outer coil 200B) may refer to a maximum value among the lengths of the plurality of line segments that connect both ends of the cross-section in the thickness direction in the aforementioned L-T cross-section photograph. A width of the cross-section of each turn of the inner coil 200A (or outer coil 200B) may refer to a maximum value among the lengths of the plurality of line segments that connect both ends of the cross-section in the width direction in the aforementioned L-T cross-section photograph.

As another example, a thickness of each turn of the cross-section of the inner coil 200A (or the outer coil 200B) may refer to the arithmetic average value of the maximum value and the minimum value among the lengths of the plurality of line segments that connect both ends in the thickness direction of the cross-section in the aforementioned L-T cross-section photograph, and a width of the cross-section of each turn of the inner coil 200A (or outer coil 200B) may refer to the arithmetic average value of the maximum value and the minimum value among the lengths of the plurality of line segments that connect both ends in the width direction of the cross-section in the aforementioned L-T cross-section photograph. However, if the corresponding cross-section has a region that protrudes or is convex in the thickness direction, this region may be excluded and the width may be measured in the remaining region.

Based on the thickness and width of the cross-section of each turn of the inner coil 200A (or outer coil 200B) measured as described above, the cross-sectional area of each turn of the inner coil 200A (or outer coil 200B) may be calculated.

As another example, the cross-sectional area of each turn of the outer coil 200B and the cross-sectional area of each turn of the inner coil 200A may be obtained by measuring the aforementioned L-T cross-section photograph using a scanning electron microscope-energy dispersive X-ray spectroscopy (hereinafter referred to as “SEM-EDX”).

Additionally, the cross-sectional area of each turn of the outer coil 200B and the cross-sectional area of each turn of the inner coil 200A shown in the aforementioned L-T cross-section photograph can be accurately measured using known image analysis software.

The first external electrode 700 may be positioned on the first surface S1 of the body 100 and connected to the first lead out portion 233 of the coil 200. The first external electrode 700 covers a portion of the sixth surface S6 of the body 100.

In another embodiment, the first external electrode 700 may cover the first surface S1 of the body 100, and may cover at least one of a portion of the third surface S3, a portion of the fourth surface S4, a portion of the fifth surface S6, and a portion of the sixth surface S6.

The second external electrode 800 may be positioned on the second surface S2 of the body 100 and connected to the second lead out portion 243 of the coil 200. The second external electrode 800 covers a portion of the body 100.

In another embodiment, the second external electrode 800 may cover the second surface S2 of the body 100, and may cover at least one of a portion of the third surface S3, a portion of the fourth surface S4, a portion of the fifth surface S6, and a portion of the sixth surface S6.

The first external electrode 700 may include a first metal layer 701, a second metal layer 702, and a third metal layer 703.

The first metal layer 701 is a plating layer that contacts the first lead out portion 233 and outer surfaces of the body 100, that is, the first surface S1 and the sixth surface S6, and may include copper (Cu). The second metal layer 702 is a plating layer that covers the first metal layer 701, and may include nickel (Ni). The third metal layer 703 is a plating layer that covers the second metal layer 702, and may include tin (Sn). However, the present embodiment is not limited to a three-layer structure; a two-layer structure, with only one additional metal layer over the first metal layer 701, is also possible.

The second external electrode 800 may include a first metal layer 801, a second metal layer 802, and a third metal layer 803.

The first metal layer 801 is a plating layer that contacts the second lead out portion 243 and outer surfaces of the body 100, that is, the second surface S2 and the sixth surface S6, and may include copper (Cu). The second metal layer 802 is a plating layer that covers the first metal layer 801 and may include nickel (Ni). The third metal layer 803 is a plating layer that covers the second metal layer 802 and may include tin (Sn). However, the present embodiment is not limited to a three-layer structure, and a two-layer structure with only one metal layer added to the first metal layer 801 is also possible.

As another example, the first external electrode 700 and the second external electrode 800 may include a metal and glass. The metal may be, for example, a conductive metal including copper (Cu), nickel (Ni), tin (Sn), palladium (Pd), platinum (Pt), gold (Au), silver (Ag), tungsten (W), titanium (Ti), lead (Pb), or an alloy thereof. The glass component included in the first external electrode 700 and the second external electrode 800 may be a mixture of oxides. The glass component may include, for example, a silicon oxide, a boron oxide, an aluminum oxide, a transition metal oxide, an alkali metal oxide, an alkaline-earth metal oxide, or a combination thereof. Here, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba). The method for forming the first external electrode 700 and the second external electrode 800 is not particularly limited. For example, the first external electrode 700 and the second external electrode 800 may be formed by dipping the body 100 into a conductive paste containing a conductive metal and glass, or by printing a conductive paste on a surface of the body 100 by, e.g., screen printing or gravure printing. In addition, various methods, such as applying a conductive paste on the surface of the body 100 or transferring a dry film formed by drying the conductive paste to the body 100, may be used to form the first external electrode 700 and the second external electrode 800.

The surface insulation layer 900 may be positioned on the third surface S3, the fourth surface S4, the fifth surface S5, and the sixth surface S6 of the body 100. However, the surface insulation layer 900 may partially cover the sixth surface S6 of the body 100. That is, the first external electrode 700 and the second external electrode 800 may be positioned on the sixth surface S6 of the body 100, and the surface insulation layer 900 may not cover the first external electrode 700 and the second external electrode 800.

As described above, the surface insulation layer 900 is positioned on at least a portion of the third surface S3, the fourth surface S4, the fifth surface S5, and the sixth surface S6 of the body 100 to prevent electrical shorts between other electronic components and the external electrodes 700 and 800.

The surface insulation layer 900 may be used as a resist when forming the external electrodes 700 and 800 by electroplating, however is not limited thereto.

The surface insulation layer may include polymer resin, pigment, filler, or the like. The polymer resin may include a thermosetting polymer resin such as epoxy or a thermoplastic polymer resin such as acryl. Pigments capable of producing color, such as black, may include carbon black, black manganese (Mn)-based spinel powder, etc., and the surface insulation layer may further include additives such as SiO₂ and talc, for control of strength and/or coefficient of thermal expansion.

For example, the surface insulation layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, a photosensitive resin, parylene, SiOx or SiNx.

The surface insulation layer 900 may be formed using processes such as screen printing, pad printing, dipping, or spray printing. For example, the surface insulation layer 900 may be formed, by applying a liquid insulating resin to a surface of the body 100, or by stacking an insulating film such as a dry film on the surface of the body 100, or through a thin film process such as vapor deposition. In the case of the insulating films, Ajinomoto Build-up Film (ABF) or polyimide film, or the like, which do not include a photosensitive insulating resin, may be used.

A thickness of a surface insulation layer 900 may be 3 μm or more and 25 μm or less. If the thickness of the surface insulation layer 900 is less than 3 μm, the magnetic material may be exposed in a portion where the surface insulation layer 900 is thin, which may cause, in an actual use environment, appearance problems such as oxidation. If the thickness of the surface insulation layer 900 exceeds 25 μm, the insulating properties may be excellent, but the volume of the body may be relatively decreased compared to the volume of the coil electronic component 1000, and accordingly, electrical properties such as inductance, direct current resistance, or rated current may deteriorate.

### PREPARATION EXAMPLE: PREPARING COIL ELECTRONIC COMPONENT

### Example 1

A coil electronic component was manufactured in which an outer layer coil with a cross-sectional area of 1150 μm² and an inner layer coil with a cross-sectional area of 1100 um² were embedded in the body.

### Example 2

It was identical to Example 1, except that the cross-sectional area of the inner layer coil was 1150 μm².

### Example 3

It was identical to Example 1, except that the cross-sectional area of the inner layer coil was 1200 μm².

### Comparative Example 1

It was identical to Example 1, except that the cross-sectional area of the inner layer coil was 950 μm².

### Comparative Example 2

It was identical to Example 1, except that the cross-sectional area of the inner layer coil was 1000 μm².

### Comparative Example 3

It was identical to Example 1, except that the cross-sectional area of the inner layer coil was 1050 μm².

### Comparative Example 4

It was identical to Example 1, except that the cross-sectional area of the inner layer coil was 1250 μm².

### Comparative Example 5

It was identical to Example 1, except that the cross-sectional area of the inner layer coil was 1300 μm².

### Comparative Example 6

It was identical to Example 1, except that the cross-sectional area of the inner layer coil was 1350 μm².

### Experimental Example: DC Resistance of Coil Electronic Components

After manufacturing fifty (50) pieces of coil electronic components each according to Examples 1 to 3 and Comparative Examples 1 to 6, the DC resistance was measured. When the DC resistance was smaller than 320 mΩ, it was deemed “suitable,” and when the DC resistance was greater than 320 mΩ, it was deemed “unsuitable.”

The results are presented in Table 1.

TABLE 1

| | Cross- | Cross- | | |
|---|---|---|---|---|
| | sectional | sectional | | |
| | area of | area of | | |
| | outer | inner | DC | |
| | layer coil | layer coil | resistance | |
| | (um²) | (um²) | (mΩ) | Determination |
| Comparative | 1150 | 950 | 373.4 | unsuitable |
| Example 1 | | | | |
| Comparative | 1150 | 1000 | 341.7 | unsuitable |
| Example 2 | | | | |
| Comparative | 1150 | 1050 | 325.8 | unsuitable |
| Example 3 | | | | |
| Example 1 | 1150 | 1100 | 312.1 | suitable |
| Example 2 | 1150 | 1150 | 309.5 | suitable |
| Example 3 | 1150 | 1200 | 311.8 | suitable |
| Comparative | 1150 | 1250 | 325.4 | unsuitable |
| Example 4 | | | | |
| Comparative | 1150 | 1300 | 342.3 | unsuitable |
| Example 5 | | | | |
| Comparative | 1150 | 1350 | 372.1 | unsuitable |
| Example 6 | | | | |

Referring to Table 1, the DC resistance of the coil electronic component according to Examples 1 to 3 was smaller than 320 mΩ. In contrast, the DC resistance of the coil electronic component according to Comparative Examples 1 to 6 exceeded 320 mΩ. This is likely because, in Comparative Examples 1 to 3, the cross-sectional area of the inner layer coil was too small compared to the cross-sectional area of the outer layer coil, and in Comparative Examples 4 to 6, the cross-sectional of the inner layer coil was too large compared to the cross-sectional area of the outer layer coil.

While this disclosure has been described in connection with what is presently considered to be practical embodiments, it is to be understood that the invention is not limited to the disclosed embodiments. Rather, the invention is intended to encompass various modifications and equivalent arrangements within the spirit and scope of the appended claims.

### DESCRIPTION OF SYMBOLS

1000: coil electronic component
100: body
200: coil
200A: inner coil
200B: outer coil
210: first inner coil pattern
220: second inner coil pattern
230: first outer coil pattern
240: second outer coil pattern
211: first via pad
212: second via pad
221: third via pad
222: fourth via pad
231: fifth via pad
241: sixth via pad
233: first lead out portion
243: second lead out portion
300: support member
410: first via
420: second via
430: third via
610: first insulation layer
620: second insulation layer
630: third insulation layer
640: fourth insulation layer
700: first external electrode
800: second external electrode
900: surface insulation layer

What is claimed is:

1. A coil electronic component comprising:
a support member;
a coil disposed on the support member; and
a body that surrounds the support member and the coil, and includes a magnetic material,
wherein the coil comprises an inner coil and an outer coil positioned sequentially relative to the support member,
the outer coil is connected to the inner coil, and
a ratio of a cross-sectional area of each turn of the inner coil to a cross-sectional area of each turn of the outer coil is 1100/1150 or more and 1200/1150 or less.

2. The coil electronic component of claim 1, further comprising:
an insulation layer disposed between the inner coil and the outer coil; and
a first via extending through the insulation layer and electrically connecting the inner coil and the outer coil.

3. The coil electronic component of claim 2, wherein:
the support member comprises a first support surface, a second support surface opposite to the first support surface, and a second via connecting the first support surface and the second support surface, and
the inner coil comprises:
a first inner coil pattern disposed on the first support surface and
a second inner coil pattern disposed on the second support surface and connected to the first inner coil pattern through the second via.

4. The coil electronic component of claim 3, wherein:
the insulation layer comprises:
a first insulation layer covering the first inner coil pattern, and
a second insulation layer covering the second inner coil pattern.

5. The coil electronic component of claim 4, wherein:
the outer coil comprises:
a first outer coil pattern disposed on the first insulation layer, and
a second outer coil pattern disposed on the second insulation layer.

6. The coil electronic component of claim 5, further comprising:
a third insulation layer disposed between the first outer coil pattern and the body; and
a fourth insulation layer disposed between the second outer coil pattern and the body.

7. The coil electronic component of claim 5, wherein:
the first outer coil pattern comprises a first lead out portion exposed on one surface of the body, and
the second outer coil pattern comprises a second lead out portion exposed on another surface of the body.

8. The coil electronic component of claim 7, further comprising:
a first external electrode disposed outside the body and connected to the first lead out portion; and
a second external electrode disposed outside the body and connected to the second lead out portion.

9. The coil electronic component of claim 1, further comprising:
a surface insulation layer disposed on an outer surface of the body.
